(19) United States
(12) Patent Application Publication
(10) Pub. No.: US 2011/0303105 A1
(43) Pub. Date: Dec. 15, 2011

(54) Multi-Tiered Non-Apertured Media Embossing and Cutting Template

(75) Inventor: J. Michael Dywan, Phoenix, AZ (US)

(73) Assignee: PMA PHOTOMETALS OF ARIZONA, INC., Phoenix, AZ (US)

(21) Appl. No.: 12/797,373

(22) Filed: Jun. 9, 2010

(51) Int. Cl. B41F 19/02

(52) U.S. Cl. 101/26; 101/30

(57) ABSTRACT

A non-apertured media embossing template (24) is formed from a non-apertured die (20). Media embossing template (24) has a raised perimeter (32) and at least one embosser (34). The raised perimeter (32) is a two-dimensional embossing perimeter integrally formed with a face of non-apertured die (20). The raised perimeter (32) can be used to emboss and/or cut a media (26), based upon the amount of force (28) applied to press media (26) onto the non-apertured die (20). Each embosser (34) has an embossing pattern that can be used to further emboss the media (26), providing either a uniform pattern for embossment on media (26), or further detail associated with raised perimeter (32). The media embossing template (24) can be precisely positioned on the media (26) by aligning registration points (56 and 58) on the media (26) and the non-apertured die (20). Registration points (56) on the media (26) may be pre-printed on media (26) using a rubber stamp or other media printing or stamping method.

### TECHNICAL FIELD OF THE INVENTION

The present invention relates to the field of media embellishment. More specifically, the present invention relates to media embellishing templates.

### BACKGROUND OF THE INVENTION

Papercraft and scrapbooking have become increasingly popular over the past many years. Many people have used the art of scrapbooking to collect and organize photographs and other mementos in ways that personalize the collections. Much of this personalization is done through the use of embellishments which are often created using templates that cut and/or emboss the media used.

Traditional press systems that use these embossment and embellishment templates utilize a two-piece die system. These traditional systems use two complementing dies such that one die has a male die having an embossing surface with raised areas and a female die that has complementary recessed areas such that the recessed areas of the female die can receive the raised areas of the male die if the dies are pressed together. In these traditional systems, the media is placed between the male and female dies, and the male and female dies are pressed together to emboss the media.

Some traditional single-die templates use apertures formed into the template to provide secondary embellishments to a pattern. In such systems, the template has both raised areas and apertures. The raised areas emboss and/or cut the media when pressure is applied. When sufficient pressure is applied, the media is further pressed into the apertures, forming a secondary embossment. These systems require control over the pressure used to press the media on the template, as an increase in the pressure may impose unwanted embellishments upon the media. The effects of this are apparent in situations where the user desires to only cut the media with the raised areas; however the pressure required to cut the media with these templates results in the unwanted side effect of additional embossment by the apertures.

The traditional single-die templates are often very thin, ranging between 0.010 inches to about 0.060 inches. The thinness reduces the time and materials needed to formulate the apertures within the single die template. However, the resultant die template often has sharp edges that may inadvertently cut media while being set up, and also may harm individuals using the die, as the sharp nature of the edges, both on the side and within the apertures, may cut skin.

Also, when a media is pressed into traditional die templates that cut the media, the media is pressed into the die, and abuts the cutting surface of the die on all sides of the cutting surface. To remove the media from the die template, traditionally a pick or other tool is used to lift a portion of the media from within the cut area, and then remove the media by pulling on the lifted portion. Due to the closeness of the media and the cutting surface, the pick or other tool is traditionally a sharp pointed device.

In addition to embossing media, papercraft and scrapbooking utilize colors and paints to personalize media and collections. In the event that users wish to embellish specific areas of their pressed media, often embellishments must be added, and the media colored and/or painted subsequent to pressing. Especially in traditional single-die templates, embellishments may be made only specific areas of the die, and thus to the media, while on the template being embossed. It is not possible for users to color and/or paint the full figure while also embossing the media, better ensuring accurate coloring and/or painting of media with regards to the embossment pattern being imposed on media.

Rubber stamps have increased the customizability of scrapbooking activities. By providing easily stampable patterns, users are provided a quick and simple method of stamping a full image upon the scrapbooking media. However, when the user desires to use the stamped figures as part of other embossments, or desires to extract the stamped image from the remaining media, often the resulting cut perimeter does not precisely match the outlines of the stamp. Furthermore, as rubber stamped images are two dimensional, users are limited as to the amount of embossing that can be done with the pattern.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a side view of a non-apertured die in accordance with a preferred embodiment of the present invention;

FIG. 2 shows a perspective view of a face of a non-apertured die in accordance with a preferred embodiment of the present invention;

FIG. 3 shows a perspective view of a face of a non-apertured die in accordance with an alternate embodiment of the present invention;

FIG. 4 shows a top view of a media in accordance with an alternate embodiment of the present invention.

FIG. 5 shows a perspective view of a face of a non-apertured die in accordance with an alternate embodiment of the present invention;

FIG. 6 shows a perspective view of a face of a non-apertured die in accordance with an alternate embodiment of the present invention; and

FIG. 7 shows a perspective view of a face of a non-apertured die in accordance with an alternate embodiment of the present invention.

### DETAILED DESCRIPTION OF THE PREFERRED EMBODIMENTS

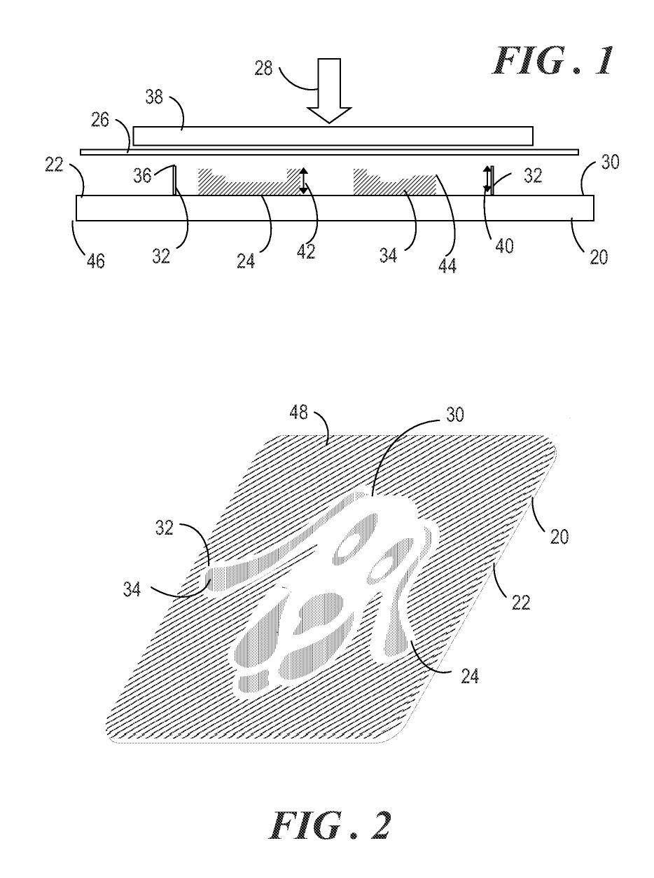

FIG. 1 is a side view of a non-apertured die 20. Non-apertured die 20 has a face 22 with a media embossing template 24 impressed upon face 22. Media embossing template 24 is a template which can be used to cut and/or emboss and otherwise embellish a media 26. In order to mold media 26 to conform to media embossing template 24 on non-apertured die 20, a force 28 is placed on media 26, pressing media 26 onto non-apertured die 20. Force 28 upon media 26, as it is pressed onto face 22 of non-apertured die 20, will cause media 26 to conform to media embossing template 24. Media embossing template 24 is imprinted upon face 22 of non-apertured die 20 by chemical etching, machining, or otherwise removing of unwanted layers of face 22. Because media embossing template 24 will have media 26 pressed onto it, non-apertured die 20 must be formed from a material that is able to withstand force 28 that may be imposed upon it. In one embodiment, non-apertured die 20 is made from a metal.

Media embossing template 24 comprises a template base 30, a raised perimeter 32 and an embosser 34. Raised perimeter 32 and embosser 34 have heights that are offset from template base 30. Raised perimeter 32 defines an outer perimeter for the figure or pattern that media embossing template 24 depicts. Raised perimeter 32 is a two-dimensional perimeter that is integrally formed with face 22, and raised from face 22 relative to template base 30. When media 26 is pressed onto face 22, raised perimeter 32 will emboss media 26 by impressing into media 26 the pattern or figure defined by raised perimeter 32. In one embodiment, the edge 36 of raised perimeter 32 distal to face 22 is a die-cut blade designed to cut media 26 when media 26 is pressed onto face 22 with sufficient force 28.

Embosser 34 is an embossing pattern confined within the area defined by raised perimeter 32. Embosser 34 provides embossments that can be pressed into media 26 when sufficient force 28 is applied such that media 26 is pressed into embosser 34. Embosser 34 may be a uniform pattern imprinted upon face 22 within the area confined by raised perimeter 32. In an alternate embodiment, embosser 34 is a pattern that provides additional embellishments to media 26 when pressed into media embossing template 24, such as additional details for the figure or pattern that raised perimeter 32 defines. In one embodiment, a force distribution media 38 is placed on the surface of media 26 distal to face 22. In one embodiment, force distribution media 38 is a solid, flexible polycarbonate plate that will not mold to media embossing template 24. In an alternate embodiment, force distribution media 38 includes a spongy material that will conform to the shape of media embossing template 24. In this embodiment, media 26 is placed between the spongy material of force distribution media 38 and face 22 of non-apertured die 20. Force 28 is applied to the surface of force distribution media 38 distal to media 26. Force 28 will cause force distribution media 38 to push media 26 into embosser 34, embossing media 26 with the pattern of embosser 34. In one embodiment, force distribution media 38 includes a rubber media.

Raised perimeter 32 has a height 40, measured from template base 30 to edge 36 of raised perimeter 32. Embosser 34 has a height 42 measured from template base 30 to the surface 44 of embosser 34 distal to template base 30. In one embodiment, embosser 34 is raised from template base 30, and height 40 of raised perimeter 32 is greater than or equal to height 42 of embosser 34. The embodiment in which height 40 of raised perimeter 32 is greater than height 42 of embosser 34 permits the perimeter embossment or die cutting of media 26 without embossing the additional details provided by embosser 34.

One skilled in the art will recognize that although only one embosser 34 has been discussed, having one height 42, that media embossing template 24 may have multiple embossers 34, each having a different height 42. In the embodiment with multiple embossers 34 with multiple heights 42, one will recognize that each height 42 of each embosser 34 raised above template base 30 will be less than or equal to the height 40 of raised perimeter 32. The relative heights of embosser 34 and raised perimeter 32 will help ensure that the user can die cut the perimeter of the desired template and emboss interior details.

One skilled in the art will recognize that although media embossing template 24 has been placed upon face 22 of non-apertured die 20, non-apertured die 20 has a second face 46, and a second media embossing template may be placed upon second face 46 of non-apertured die 20. If a media embossing template is placed upon second face 46, the pattern may be a complement to media embossing template 24 on face 22. In an alternate embodiment, the pattern on second face 46 is unrelated to media embossing template 24 found on face 22 of non-apertured die 20.

FIG. 2 is a perspective view of non-apertured die 20 with the use of a foam or other substance 48 disposed surrounding raised perimeter 32. Foam or other substance 48 may be used to surround raised perimeter 32 and extend from face 22 of non-apertured die 20 to the edge 36 of raised perimeter 32. Foam or other substance 48 can serve as a guard against potential injury a user may suffer if raised perimeter 32 is a die cut blade. Also, foam or other substance 48 can serve to alter media embossing template 24 so that the area of face 22 not enclosed by raised perimeter 32 is aligned with the edge 36 of raised perimeter 32. This will result in a different embossment of media 26 (shown in FIG. 1), as the area of media 26 that is pressed onto the area of face 22 not enclosed by raised perimeter 32 will not be aligned with template base 30. Thus, when force 28 (shown in FIG. 1) is applied to media 26, media 26 will conform to the shape defined by raised perimeter 32 within the area enclosed by raised perimeter 32, however will not be altered in the area outside the area enclosed by raised perimeter 32.

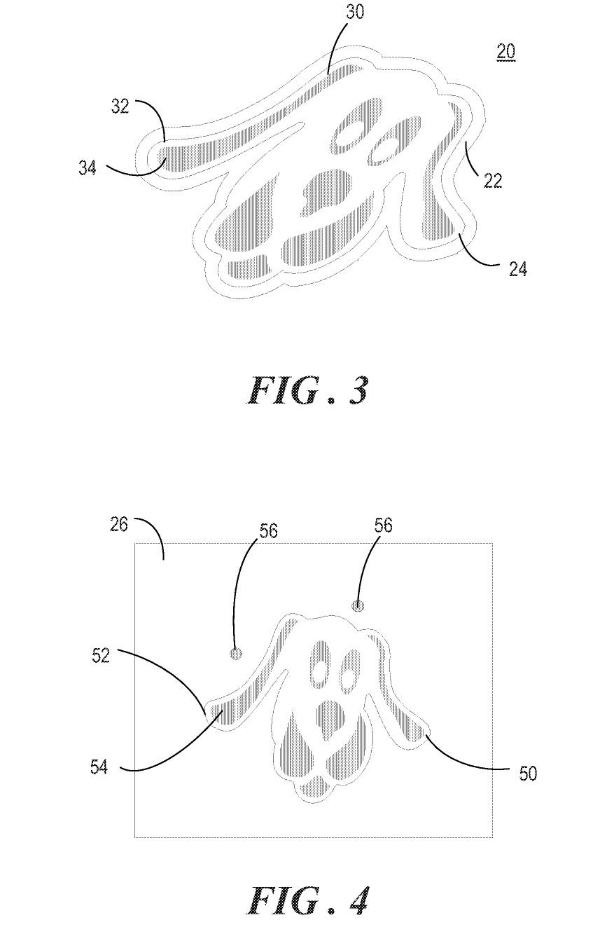

FIG. 3 is a perspective view of non-apertured die 20 showing media embossing template 24 on face 22. In this embodiment, face 22 of non-apertured die 20 has been confined to an outline of raised perimeter 32. By reducing the face 22 of non-apertured die 20 that extends beyond media embossing template 24, the user is able to better position non-apertured die 20 on media, as the accuracy of approximating the position of media embossing template 24 on media 26 (shown in FIG. 1) is increased. Furthermore, a user may place multiple non-apertured dies 20 together in a desired close pattern, permitting the application of a single force 28 (shown in FIG. 1) to emboss multiple patterns on media 26.

By providing a multi-level embossing system, non-apertured die 20 can provide a user with multiple options to emboss media 26 with a single die by varying the force 28 that is applied to press media 26 into media embossing template 24, by using different force distribution media 38 (shown in FIG. 1), and by attaching or removing foam or other substance 48 (shown in FIG. 2). In one embodiment, a user of non-apertured die 20 may emboss a raised perimeter 32 into media 26. In another embodiment, the figure or pattern defined by raised perimeter 32 may be cut into media 26. In still another embodiment, foam or other substance 48 may be used to align the edge 36 of raised perimeter 32 with the area of die outside of raised perimeter 32, such that embellishments are impressed on the area enclosed by raised perimeter 32 only. The embodiments discussed above may be further embossed by using additional force 28 to push media 26 into embosser 34.

Media embossing template 24 can be formed using any die forming technology. For example, media embossing template 24 may be formed by machining and shaving away the unwanted areas of face 22 such that raised perimeter 32 and embosser 34 are formed. In an alternative embodiment, media embossing template 24 may be formed by etching face 22 such that the unwanted areas of face 22 are chemically removed. One skilled in the art would recognize that although machining and etching methods of die forming are discussed, any other method of creating dies can be used to create media embossing template 24. Furthermore, one skilled in the art will recognize that when forming media embossing template 24, any combination of any method of creating dies can be used to imprint raised perimeter 32 and embosser 34 into face 22.

The non-apertured nature of non-apertured die 20 provides the user with multiple options to customize, emboss and otherwise embellish media 26. By providing the multi-level embossing system that can be used to emboss and embellish a media 26, the user is provided with multiple options on a single die of how to personalize their works. The user can select to only cut or emboss an outline as provided by raised perimeter 32, or can select to cut or emboss outline and apply additional embellishments or embossments by applying greater force 28 and pressing media 26 into embosser 34.

When using embosser 34, the user is not limited to simply embossing media 26. In one embodiment, paints and/or other coloring media 26 may be used with media embossing template 24. The personalization afforded by using paints and/or other coloring media 26 can be implemented by applying paint and/or other coloring media 26 upon the entire area enclosed by raised perimeter 32 such that media 26 is colored by the paint and/or other coloring media 26 when media 26 is pressed into media embossing template 24. More localized colorization may be effected by applying paint and/or other coloring media 26 within embosser 34. This provides the user with multiple colorable surfaces at different depths. The user may select to only color embosser 34, only raised perimeter 32, only template base 30, or any combination of the three.

FIG. 4 is a top view of media 26 with a pre-stamped pattern 50. Pre-stamped pattern 50 can be placed on media 26 by using rubber stamps, printing methods, or any other method. Pre-stamped pattern 50 may be a solid pattern, without any details, or can include intricate details. In the embodiment shown in FIG. 4, the face of a dog includes a perimeter 52, and facial details 54. One skilled in the art will recognize that although a face of a dog is used, any picture, figure or template may be used, and that any additional details may be printed within the picture, figure or template. In addition to pre-stamped pattern 50, media registration points 56 may be stamped on media 26.

Media registration points 56 are points placed external to the perimeter of pre-stamped pattern 50 that can be used to align media embossing template 24 with pre-stamped pattern 50 in order to align raised perimeter 32 and embosser 34 with pre-stamped pattern 50. Alignment of pre-stamped pattern 50 and media embossing template 24 will be discussed in more detail below.

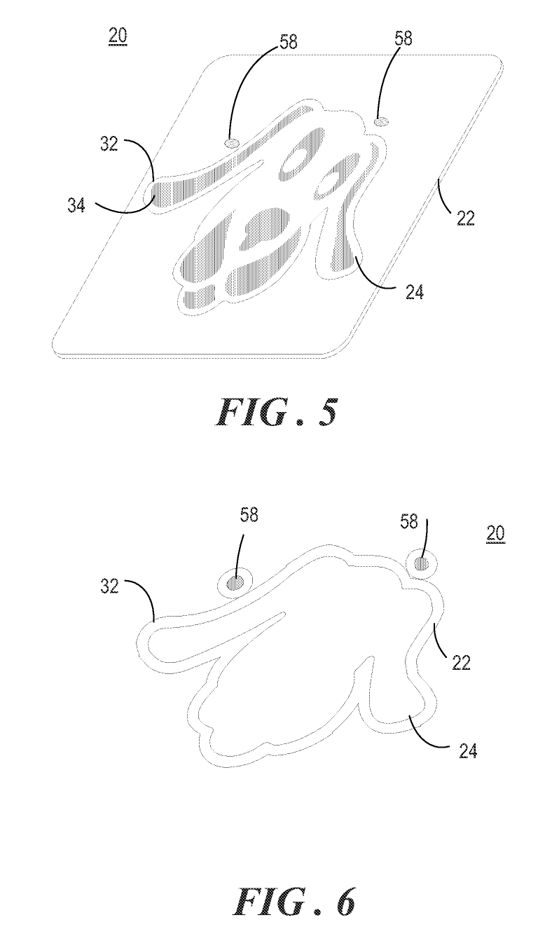

FIG. 5 is a perspective view of non-apertured die 20 showing media embossing template 24 on face 22. Raised perimeter 32 can take the form of any two-dimensional perimeter that defines any figure or pattern that may be desired. One skilled in the art will recognize that although FIG. 5 shows a template of a dog's face, any figure or pattern may be imprinted to form media embellishing template 24 upon non-apertured die 20. In the embodiment shown in FIG. 5, raised perimeter 32 defines the outer perimeter of the dog's face template imprinted on face 22. Embosser 34 provides additional embossing and embellishing features that can be used to provide more detail to media 26 (shown in FIG. 1). In the embodiment shown in FIG. 2, embosser 34 provides additional details such as the eyes, mouth and ears of dog's face template.

In one embodiment, non-apertured die 20 is used in conjunction with pre-stamped pattern 50 (shown in FIG. 4). In this embodiment, media embossing template 24 is aligned with pre-stamped pattern 50, and die registration points 58 on non-apertured die 20 are used to align non-apertured die 20 with pre-stamped pattern 50 on media 26 (shown in FIG. 4). When non-apertured die 20 is aligned using die registration points 58 and media registration points 56 (shown in FIG. 4), raised perimeter 32 of media embossing template 24 will be aligned with the perimeter of pre-stamped pattern 50. By applying force 28 (shown in FIG. 1) to media 26 aligned with non-apertured die 20, a user can precisely die-cut, or emboss media 26 with additional details using embosser 34. Details defined by embosser 34 may be those that are visible in the pre-stamped pattern, or additional details.

One skilled in the art will recognize that although FIG. 5 shows die registration points 58 as external points that are enclosed by face 22 of non-apertured die 20, non-apertured die 20 may have other methods of aligning media embossing template 24 with pre-stamped pattern 50. One example is the use of indentations along non-apertured die 20 that are positioned where die registration points 58 are shown.

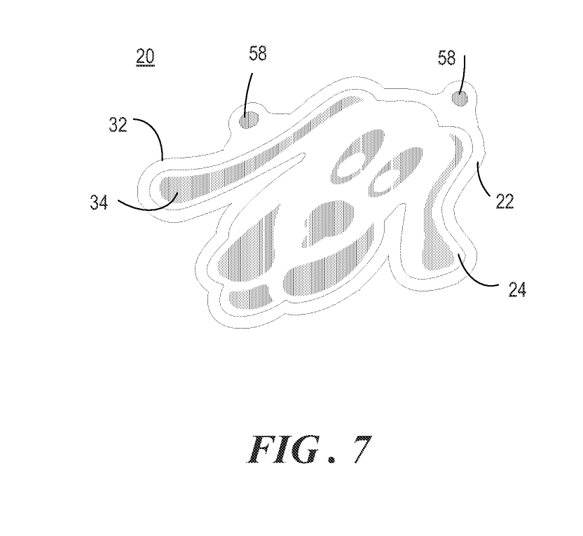

FIGS. 6 and 7 are perspective views of non-apertured die 20 showing media embossing template 24 on face 22. In both of these embodiments, registration points 58 are are included in non-apertured die 20. As in FIG. 4, the face 22 of non-apertured die 20 has been reduced, permitting the user of multiple non-apertured dies 20 in close proximity. The use of die registration points 58 permits a user to more accurately position media embossing template 24 on media 26 (shown in FIG. 4).

FIG. 6 shows a non-apertured die 20 having registration points 58 and raised perimeter 32. In one embodiment, raised perimeter 32 is a die-cut blade that, when aligned with a pre-stamped pattern on media 26 (shown in FIG. 4), can cut media 26 along the perimeter of the pre-stamped pattern. As the die-cut of raised perimeter 32 can be etched to include a complex perimeter, the resulting cut can be as precise as the pre-stamped pattern. This provides a more accurate and clean cut media 26 that can include many intricate details of the pre-stamped pattern.

FIG. 7 shows a non-apertured die die 20 having registration points 58, raised perimeter 32 and embosser 34. As described in FIG. 5, in one embodiment, raised perimeter 32 is a die-cut blade that, when aligned with a pre-stamped pattern 50 (shown in FIG. 4) on media 26 (shown in FIG. 4), can cut media 26 along the perimeter of pre-stamped pattern 50. Additionally, embosser 34 provides details that can be embossed into media 26. In one embodiment, embosser 34 is created to align with details found in pre-stamped pattern 50, permitting the user to precisely and accurately emboss media 26 with details of pre-stamped pattern 50 by aligning media embossing template 24 on media 26 using die registration points 58.

In summary, the present invention teaches teaches a non-apertured die 20 with a media embossing template 24 on a face 22 to be used in papercraft and scrapbooking. Media embossing template 24 has a raised perimeter 32 and at least one embosser 34, reducing the number of dies that a user may have to possess to embellish and otherwise emboss media 26 as desired. Furthermore, non-apertured die 20 is designed to be used individually, thus removing the need of owning matching male and female dies to form the desired embossments and embellishments on media 26.

By providing a non-apertured die 20, the user is permitted to apply as much force 28 as necessary on media embossing template 24 to cause the desired embossment or embellishment on media 26. Also, the non-apertured nature of non-apertured die 20 permits non-apertured die 20 itself to have an increased thickness such that potential dangers of user injury due to sharp edges is reduced.

The embossing pattern of embosser 34 can be used to provide not only embossment of the media 26, but also further embellishments. By painting or otherwise coloring recessed embosser 34 of media embossing template 24, non-apertured die 20 can be used to paint and/or color a full image or pattern on media 26 as desired while, at the same time, embossing media 26. Thus, the user can better control the distribution of paint and/or other colors by painting or otherwise coloring media embossing template 24 of non-apertured die 20 and removing unwanted paint and/or color from media embossing template 24 prior to embossing media 26.

By providing multi-level embossers 34, media 26 can be embossed in differing levels of detail by adjusting the amount of force 28 applied to media 26. Additionally, the use of multi-level embossers 34 provides additional levels for customizations, such as colors and paints.

Registration points are used to align media embossing template 24 on media 26, providing for the accurate placement of media embossing template 24, and increasing the accuracy of embossments and cuts made on media 26. By aligning media embossing template 24 with pre-stamped patterns 50, such as rubber stamps, made on media 26, a user is able to obtain a precise and accurate die cut of the pattern that has been pre-stamped.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A dry media embossing template comprising:
a non-apertured die having an embossing face configured to emboss a media, said embossing face comprising a raised perimeter, at least one embosser;
wherein:
said raised perimeter is formed integrally with said non-apertured die and extends from said face; and
said raised perimeter and said at least one embosser are configured to emboss said media.

2. A dry media embossing template as claimed in claim 1 wherein said raised perimeter further comprises a die cut blade.

3. A dry media embossing template as claimed in claim 1 wherein said raised perimeter is etched into said non-apertured die.

4. A dry media embossing template as claimed in claim 1 wherein said at least one embosser comprises an embossing pattern.

5. A dry media embossing template as claimed in claim 4 wherein said embossing pattern is enclosed within said raised perimeter.

6. A dry media embossing template as claimed in claim 1 wherein:
said raised perimeter has a first height;
said at least one embosser has at least one height; and
said first height of said raised perimeter is greater than said at least one height of said at least one embosser.

7. A dry media embossing template as claimed in claim 1 wherein said non-apertured die is formed from an etched material.

8. A dry media embossing template as claimed in claim 7 wherein said non-apertured die is formed from metal.

9. A dry media embossing template as claimed in claim 1 wherein:
said non-apertured die further comprises least two registration points configured to position said raised perimeter on said media.

10. A dry media embossing template alignment system comprising:
a non-apertured die having an embossing face configured to emboss a media; and
a registration system configured to position said embossing face on said media, said registration system comprising at least two registration points on said non-apertured die configured to position said embossing face on said media.

11. A dry media embossing template alignment system as claimed in claim 10 wherein:
said registration system further comprises at least two registration point on said media; and
said positioning of said embossing face on said media aligns said at least two registration points on said non-apertured die with said at least two registration points on said media.

12. A dry media embossing template alignment system as claimed in claim 11 wherein:
said at least two registration point on said media are stamped on said media with a rubber stamp.

13. A dry media embossing template alignment system as claimed in claim 10 wherein:
said embossing face comprising a raised perimeter, and at least one embosser;
said raised perimeter is formed integrally with said non-apertured die and extends from said face; and
said raised perimeter and said at least one embosser are configured to emboss said media.

14. A dry media embossing template alignment system as claimed in claim 10 wherein said raised perimeter further comprises a die cut blade.

15. A dry media embossing template alignment system as claimed in claim 10 wherein said raised perimeter is etched into said non-apertured die.

16. A dry media embossing template alignment system as claimed in claim 10 wherein said at least one embosser comprises an embossing pattern.

17. A dry media embossing template alignment system as claimed in claim 16 wherein said embossing pattern is enclosed within said raised perimeter.

18. A dry media embossing template alignment system as claimed in claim 10 wherein:
said raised perimeter has a first height;
said at least one embosser has at least one height; and
said first height of said raised perimeter is greater than said at least one height of said at least one embosser.

19. A dry media embossing template alignment system as claimed in claim 10 wherein said non-apertured die is formed from an etched material.

20. A dry media embossing template alignment system as claimed in claim 19 wherein said non-apertured die is formed from metal.
